(19) United States
(12) Patent Application Publication
(10) Pub. No.: US 2025/0026182 A1
(43) Pub. Date: Jan. 23, 2025

(54) AIR FILTER AND VEHICLE AIR CONDITIONER EQUIPPED THEREWITH

(71) Applicants: MAHLE INTERNATIONAL GMBH, Stuttgart (DE); KARLSRUHER INSTITUT FÜR TECHNOLOGIE, Eggenstein-Leopoldschafen (DE)

(72) Inventors: Andrei BOLOGA, Stutensee (DE); Daniel EBERLE, Ludwigsburg (DE); Sven PETZNER, Welzheim (DE); Hans-Joachim GEHRMANN, Weingarten (DE)

(21) Appl. No.: 18/769,577

(22) Filed: Jul. 11, 2024

(30) Foreign Application Priority Data
Jul. 18, 2023 (DE) 102023206805.2

(51) Int. Cl. B60H 3/00; B01D 46/00; B03C 3/12; B03C 3/155; B03C 3/41; B03C 3/45; B03C 3/66; B60H 3/06

(52) U.S. Cl. CPC B60H 3/0078; B01D 46/0032; B03C 3/12; B03C 3/155; B03C 3/41; B03C 3/45; B03C 3/66; B60H 3/0658; B03C 2201/10; B03C 2201/30; B60H 2003/0691

(57) ABSTRACT

An air filter, through which a flow path for an air flow passes is provided, wherein the air filter contains an ionizer in the flow path for ionizing the air flow, in particular for ionizing the particles therein, and an electrostatically charged filter element downstream of the ionizer in the flow path for filtering the air flow, such that the air flow can pass through the ionizer and the filter element, wherein the ionizer contains an electrode that can be connected to a high voltage source for the air filter to generate a corona discharge in the air flow, and a counter electrode dedicated to the at least one electrode. Essential to the invention is that the at least one counter electrode is electrically connected to an electrically conductive filter layer in the filter element.

A vehicle air conditioner that is equipped with at least one such air filter is provided.

### CROSS-REFERENCE TO RELATED APPLICATIONS

This application claims priority from German Patent Application No. 102023206805.2, filed Jul. 18, 2023, the entirety of which is hereby fully incorporated by reference herein.

The invention relates to an air filter according to the preamble of claim 1. The invention also relates to a vehicle air conditioner that is equipped with at least one air filter.

An air filter of the above type is disclosed in WO 2020 263 171 A1. Other air filters are described in EP 3 056 364 B1, US 20 210 021 107 A1, WO 2021 226 639 A2, KR 102 205 159 B1, EP 3 488 933 A1, and US 2016 229 267 A1.

These air filters are used to cleanse air of pollutants such as particulates, noxious gasses (hydrocarbons, nitrogen oxides) and unpleasant odors (ammonia, trimethylamine, hydrogen sulfide, etc.). They are used in particular in vehicle air conditioners, where they cleanse air entering the passenger compartment in a vehicle. This results in a pleasant and healthy atmosphere in the passenger compartment with high air quality.

Urban spaces pose a challenge to these air filters. The air there can be extremely polluted with potentially harmful particulates. Pollution levels have been observed in cities that are higher than the daily mean value PM_{2.5} of 15 μg/m³ recommended by the World Health Organization (WHO). These conditions place high demands on air filters, which need to be able to effectively filter out such particulates in these urban spaces over long periods of time without requiring special maintenance.

To achieve this, manufacturers of these air filters have begun to charge filter elements in air conditioners electrostatically. This results in an electrostatic field in the filter elements that attracts electrostatic particles in the air and filters them out. This electrostatic filtering effectively removes the finest particles, in particular particulates less than 0.3 μm, from the air.

Unfortunately, the electrostatic charge in a filter element becomes weaker over time, in particular as the filter element deteriorates and/or becomes clogged. This results in a continuous reduction in electrostatic filtering.

Ionizers are used in existing air filters to counteract the weakening of the electrostatic charge in the filter element. They charge gas molecules in the air by electrostatically generating a negative or positive corona discharge. These ionized gas molecules then bond to the particles in the air flowing through the filter elements, thus improving their filtering effect. After a more or less lengthy operation, these air filters can also fail to satisfy the filtering capacity requirements. This then requires maintenance, and potentially replacement of the filter element.

The object of the invention is to create an improved, or at least different, air filter. In particular, a vehicle air conditioner that has such an air filter is to be obtained.

This problem is solved with the present invention by the subject matter of the independent claims. Advantageous embodiments are the subject matter of the dependent claims and the description.

The invention acknowledges that the filtering capacity of a filter element and the service life of the filter element can be increased by a better polarization of the air filter.

An air filter is therefore proposed for a vehicle air conditioner in particular, through which air flows. The air filter has an ionizer in the flow path that ionizes the air flow, and a electrostatically charged filter element downstream of the ionizer that filters the air flow. There are essentially no other components upstream of the ionizer. The ionizer also has at least one electrode that can be connected to a high voltage source for the air filter to generate a corona discharge in the air flow, and at least one counter electrode dedicated to the at least one electrode. It is essential to the invention that the at least one counter electrode is electrically connected to an electrically conductive, laminar filter layer in the filter element. This results in an air filter with which a polarization effect can be obtained between ionizer and the filter element, with which the filtering capacity and service life of the filter element are significantly improved, even if the filter element is relatively old.

It is clear to the person skilled in the art that this ionizing of the air flow does not mean anything other than an electrostatic charging of the gas molecules in the air and the particles in the air flow.

Ideally, a first electrical potential is applied to the at least one electrode by the high voltage source, and a different electrical potential is applied to the at least one counter electrode when the filter is in operation. This results in an electrostatic field between the ionizer and the filter element that exerts a polarizing effect on the ions generated by the corona discharge and other particles in the air flow. This effect results in a significant improvement in the filtering obtained with the filter element, even if it is already old.

The first electric potential can be a supply potential, and the second electric potential can be a counter potential. The reverse, in which the first electric potential is the counter potential and the second electric potential is the supply potential, is also conceivable. The counter potential can be obtained, for example, by grounding the at least one counter electrode and the filter layer in the filter element. The counter potential can be zero, in particular.

Ideally, a negative or positive potential difference (voltage potential) is or can be applied between the at least one electrode and the at least one counter electrode and the filter layer. This potential difference is determined by the difference between the first electric potential and second electric potential.

The negative potential difference can be −5 kV to −15 kV, or preferably −7 kV, or −11 kV in particular. This means that the at least one electrode can produce a negative corona discharge, which results in a better ionization of the particles in the air flow than with a positive corona discharge, and therefore a better filtering by the air filter. The air filter could also be configured and operated such that the at least one electrode in the air flow produces a positive corona discharge.

The ionizer can be at a distance of 0 mm to 30 mm, preferably 7 mm, from the downstream filter element. When this is the case, a relatively large electrostatic field can be obtained between the ionizer and the filter element, such that a polarizing effect can be maintained for a relatively long time, thus obtaining a good filtering effect. At the same time, this results in a relatively compact air filter that satisfies the size requirements for use in a vehicle air conditioner. The acknowledges that an optimal relationship can be obtained between the polarization effect of the electrostatic field and the size of the air filter.

The filter element can also contain a dielectric layer for particle filtering. The dielectric layer is ideally made of a material that conducts electricity poorly or an insulating material. In particular, it can form an electrostatic field.

The dielectric layer is ideally placed on the filter layer on the side of the filter element facing the ionizer and the air flow. This means that the dielectric layer is upstream of the filter layer, such that air flows through it prior to flowing through the filter layer. The dielectric layer can also be placed on the filter layer on the downstream side of the filter element facing away from the ionizer and the air flow. The dielectric layer can also form the filter layer for removing particles, or the filter layer can form the dielectric layer.

The filter layer can also contain or be made of an electrically conductive layer, in particular an activated carbon layer. This filter layer reliably removes noxious gases such as hydrocarbons and nitrogen oxides and other unpleasant odors such as ammonia, trimethylamine, hydrogen sulfide, etc. from the air flow.

The filter element is also ideally pleated.

There are numerous possible designs for the at least one electrode and the at least one counter electrode. Ideally, the at least one electrode has the form of a needle or cone with a central axis, and the at least one counter electrode is ring-shaped or cylindrical, such that it has an inner volume. The electrode can be placed in relation to the counter electrode such that the central axis thereof is parallel and preferably coaxial to the central axis of the counter electrode. The electrode can therefore be placed substantially entirely, or entirely, inside the counter electrode, with the tip of the electrode facing the air flow. The diameter of the counter electrode is ideally between 40 mm and 90 mm, preferably 50 mm. Furthermore, the at least one electrode and the at least one counter electrode can be made of stainless steel to reduce costs.

The air conditioner also ideally contains two or more electrodes and two or more counter electrodes dedicated thereto, in which case all of the electrodes are electrically connected to one another and all of the counter electrodes are electrically connected to one another. The air filter can also contain at least one more electrode and at least one more counter electrode, which is dedicated to the at least one more electrode. In this case, the at least one electrode and the at least one more electrode are electrically connected to one another. Furthermore, the at least one counter electrode and the at least one more counter electrode are also electrically connected to one another. The air filter therefore contains an assembly composed of at least two electrodes and an assembly composed of at least two counter electrodes, each of which is dedicated to one of the at least two electrodes. The air filter can also contain numerous electrodes and counter electrodes, in which case all of the counter electrodes are electrically connected to one another, and all of the electrodes are electrically connected to one another, and each of the electrodes has a dedicated counter electrode.

Another aspect of the invention relates to a vehicle air conditioner, which is installed in a vehicle and designed for use in the passenger compartment thereof. The important thing is that it is equipped with at least one of the air filters described above. An advantageous vehicle air conditioner is obtained in this manner that can effectively improve the air quality in the passenger compartment over a comparatively long service life as a result of the at least one air filter.

In summary, the present invention relates to an air filter through which air flows, which has an ionizer and a downstream electrostatically charged filter element in the air flow, and the ionizer contains an electrode that can be connected to a high voltage source for the air filter to generate a corona discharge in the air flow, and a counter electrode dedicated thereto. An essential part of the invention is that counter electrode is connected to an electrically conductive, laminar filter layer in the filter element. The invention relates in particular to a vehicle air conditioner that is equipped with at least one such air filter.

Further important features and advantages of the invention can be derived from the dependent claims, the drawings, and the description in reference to the drawings.

It is clear that the features described above and explained below can be used not only in the given combinations, but also in other combinations, or in and of themselves, without abandoning the framework of the invention.

Preferred embodiments of the invention are shown in the drawings and shall be explained in greater detail below, in which the same reference symbols are used for the same, similar, or functionally identical components.

Therein, schematically:

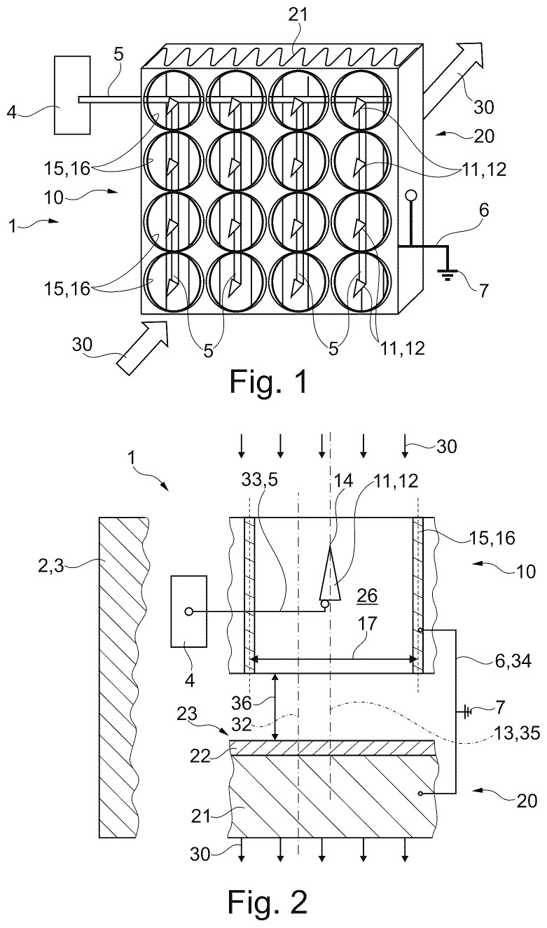

FIG. 1 shows a perspective view of a preferred embodiment of an air filter, and

FIG. 2 shows a sectional view of the air filter shown in FIG. 1.

FIGS. 1 and 2 show a preferred, highly simplified embodiment of an air filter 1, preferably for a vehicle interior, which is contained in a housing 3 for a vehicle air conditioner 2 in a vehicle, not shown.

FIGS. 1 and 2 show that there a flow path 32, only shown in FIG. 2, through which an air flow 30, indicated by the arrows in FIGS. 1 and 2, flows through the air filter. This air flow 30 is obtained from the air outside the vehicle, which is conducted into the passenger compartment of a vehicle. The air flow 30 contains undesired particles, e.g. particulates, in particular in urban environments, which are to be filtered out of the air flow 30 by the air filter 1. The air filter 1 contains an ionizer 10 in the flow path 32 for ionizing the air flow 30, and a downstream electrostatically charged filter element 20 for filtering the air flow 30. It can be seen from FIGS. 1 and 2 that the entire air flow 30 flows through the ionizer 10 and the filter element 20. Gases in the air flow 30 are ionized by the ionizer 10, which then deposit on the particulates that are roughly 10⁴ times larger, thus charging them. These charged particles then ensure an increased particle removal in the downstream filter element 20, as shall be explained below.

The ionizer 10 in the air filter 1 contains numerous electrodes 11 lying in the same plane, which generate a positive or negative corona discharge in the air flow 30. They each have needle or cone-shaped bodies 12 made of stainless steel, which are indicated in FIGS. 1 and 2 by simple triangles. The electrode bodies 12 have central axes 13 and a tip 14 that faces the air flow 30, see FIG. 2. These electrodes 11 can be mass produced inexpensively. The electrodes 11 are electrically connected to a high voltage source 4, indicated by a simple square in FIGS. 1 and 2, for the air filter 1, by a first electrical conductor 5. The high voltage source 4 supplies a relatively high electric potential to the electrodes 11.

The ionizer 10 also has numerous counter electrodes 15 lying in the same plane, each of which is dedicated to an electrode 11. The counter electrodes 15 are ring-shaped or cylindrical, with a diameter 17 of 40 mm to 90 mm, preferably 50 mm. These counter electrodes 16 each have an inner volume 26. The counter electrode bodies 16 are also made of stainless steel in order to reduce costs. FIGS. 1 and 2 show that the counter electrodes 15 and the electrodes 11 are placed in relation to one another such that the electrode bodies 12 are, substantially entirely or entirely, inside the interior 26 of the counter electrode bodies 16. The electrode bodies 12 in the respective interiors 26 are ideally aligned such that their central axes 13 are parallel and coaxial to the central axes 35 of the counter electrode bodies 16.

The filter element 20 for the air filter 1 can be pleated and/or made of a single piece. In the present case it has a layered structure, comprising an electrically conductive, laminar filter layer 21 and a dielectric layer 22 for filtering out particles. It could also have other layers. The filter layer 21 can contain an activated carbon layer or be made entirely thereof. The dielectric layer 22 is ideally made of a material that conducts electricity poorly, or an insulating material, and is also ideally placed on the filter layer 21 on a side 23a of the filter element 20 facing the ionizer 10 and the air flow 30. The dielectric layer 22 is therefore upstream of the filter layer 21 in the air flow 30, such that air passes through it prior to passing through the filter layer 21. The dielectric layer 22 is or forms a particle filtering layer, in particular the filter layer 20. Conventional hybrid filters are basically made of two filtering layers, e.g. a polymer fiber layer for removing particles and an activated carbon layer for removing gases. The activated carbon layer can be in contact with a counter electrode, because activated carbon is a good conductor. The dielectric layer 22 can also be placed on the filter element 21 on the side 23b of the filter element 20 facing away from the ionizer 10 and the air flow 30.

The ionizer 10 is placed in relation to the filter element 20 such that the distance 36 between them is 0 mm to 30 mm, preferably 7 mm.

It is essential to the invention that the counter electrode 15 is electrically connected to the electrically conductive filter layer 21 in the filter element 20 by a second electrical conductor 6. Consequently, a first electric potential 33 from the high voltage source 4 can be applied to the electrodes 11 when the air filter is in operation, while a second, different, electric potential 34 is or can be applied to the counter electrodes 15 and the filter layer 21. By way of example, the first electric potential 33 can be a supply potential and the second electric potential 34 can be a counter potential. The latter is preferably obtained in that the second electrical conductor 6 is connected to a point 7 that is grounded, for example. This results in a negative potential difference between the first electric potential 33 and the second electric potential 34. This can be −5 kV to −15 kV, or preferably exactly −7 kV, and in particular −11 kV.

This results in the following: when the air filter 1 is in operation, the external air flow 30 flows through the air filter 1 and undesired particles, e.g. particulates, noxious gases, and unpleasant odors pass by the electrodes 11. The first electric potential 33 is applied to them, such that a potential difference of e.g. −7 kV is obtained between the electrodes 11 and the counter electrodes 15 and filter layer 21. This generates a corona discharge near the electrodes 11 in the air flow 30, such that gas molecules in the air flow 30 are electrostatically charged (ionized). The ionized gas molecules then bond to the undesired particles in the air flow 30, such that they can also be regarded as electrostatically charged (ionized). The counter electrodes 15 and the filter layer 21 that are both connected to the counter potential form a counter potential to the electrodes 11. This results in the formation of an electrostatic field between the electrodes 11 and the filter layer 21 when the air filter 1 is in operation, which reinforces the electrostatic charging of the filter element 20, and/or exerts a polarizing effect on the electrostatically charged particles in the air flow. This results in a filtering of the particles even when the filter is old.

The electrodes 11 are ideally supported on the electrical conductor 5. Moreover, the ionizer 10 shown in FIGS. 1 and 2 can ideally only be operated when the electrical conductor 5 is installed in front of the electrodes, e.g. the electrical conductor 5 is placed in front of the ionizer 10 in the direction of the air flow 30. In this configuration, the distance between the ionizer 10 and the filter element 20 is preferably 7 mm. The electrical conductor 5 can also be placed between the ionizer 10 and the filter element 20, i.e. beneath the ionizer 10 and the surface of the filter layer 21. In this case, an electrical polarization field can be generated between the ionizer 10 and the surface of the filter 21. An electrical polarization field can also be generated between the electrical conductor 5 and the surface of the filter layer 21. In this case, no electrical field is generated between the electrodes 11 and the surface of the filter 21.

The specification can be readily understood with reference to the following Representative Paragraphs:
Representative Paragraph 1. An air filter (1), in particular for a vehicle air conditioner (2), through which a flow path (32) for an air flow (30) passes,
   wherein the air filter (1) contains an ionizer (10) in the flow path (32) for ionizing the air flow (30), in particular for ionizing the particles therein, and an electrostatically charged filter element (20) downstream of the ionizer (10) in the flow path (32) for filtering the air flow (30), such that the air flow (20) can pass through the ionizer (10) and the filter element (20),
   wherein the ionizer (10) contains at least one electrode (11) that is or can be connected to a high voltage source (4) for the air filter (1) to generate a corona discharge in the air flow (30), and at least one counter electrode (15) dedicated to the at least one electrode (11),
      characterized in that
   the at least one counter electrode (15) is electrically connected to an electrically conductive filter layer (21) in the filter element (20).
Representative Paragraph 2. The air filter (1) according to Representative Paragraph 1, characterized in that
   when the air filter (1) is in operation, a first electric potential (33) is or can be applied to the at least one electrode (11), and a second, different, electric potential (34) is or can be applied to the at least one counter electrode (15) and the filter layer (21).
Representative Paragraph 3. The air filter (1) according to Representative Paragraph 1 or 2, characterized in that
   the first electric potential (33) is a supply potential, and the second electric potential (34) forms a counter potential to the supply potential.
Representative Paragraph 4. The air filter (1) according to any of the preceding Representative Paragraphs, characterized in that
   when the air filter (1) is in operation, a negative or positive potential difference (voltage potential) can be or is applied between the at least one electrode (11) and the at least one counter electrode (15) and the filter layer (21).
Representative Paragraph 5. The air filter (1) according to Representative Paragraph 4, characterized in that
   the negative potential difference is −5 kV to −15 kV, or preferably −7 kV.
Representative Paragraph 6. The air filter (1) according to any of the preceding Representative Paragraphs, characterized in that
   the ionizer (10) is at a distance (30) to the downstream filter element (30) of 0 mm to 30 mm, preferably 7 mm.
Representative Paragraph 7. The air filter (1) according to any of the preceding Representative Paragraphs, characterized in that
   the filter element (20) contains a dielectric layer (22) for filtering out particles.
Representative Paragraph 8. The air filter (1) according to Representative Paragraph 7, characterized in that
   the dielectric layer (22) is placed on the filter layer (21) on a side (23a) of the filter element (20) facing the ionizer (10) and the air flow (30), and/or
   the dielectric layer (22) is placed on the filter layer (21) on a side (23b) of the filter element (21) facing away from the ionizer (10) and the air flow (30).
Representative Paragraph 9. The air filter (1) according to any of the preceding Representative Paragraphs, characterized in that
   the filter layer (21) contains or is formed by an electrically conductive layer, in particular an activated carbon layer.
Representative Paragraph 10. The air filter (1) according to any of the preceding Representative Paragraphs, characterized in that
   the at least one electrode (11) has a needle or cone-shaped electrode body (12) with a central axis (13),
   the at least one counter electrode (15) has an annular or cylindrical counter electrode body (16) that delimits an interior volume (26),
   wherein the electrode body (12) is placed in the counter electrode body (16) such that the central axis (13) of the electrode body (12) is parallel and preferably coaxial to the central axis (35) of the counter electrode body (16),
   wherein the electrode body (12) is substantially entirely, or entirely, inside the interior volume (26) of the counter electrode body (16), and
   wherein a tip (14) of the needle or cone-shaped electrode body (12) faces the air flow (30).
Representative Paragraph 11. The air filter (1) according to any of the preceding Representative Paragraphs, characterized in that
   there are two or more electrodes (11) and two or more counter electrodes (15) dedicated to the respective electrodes (11),
   wherein the electrodes (11) are electrically connected to one another,
   wherein the counter electrodes (15) are electrically connected to one another.
Representative Paragraph 12. A vehicle air conditioner (2) that is equipped with at least one air filter (1) according to any of the preceding Representative Paragraphs.

1. An air filter, in particular for a vehicle air conditioner, through which a flow path for an air flow passes,
wherein the air filter contains an ionizer in the flow path for ionizing the air flow, in particular for ionizing the particles therein, and an electrostatically charged filter element downstream of the ionizer in the flow path for filtering the air flow, such that the air flow can pass through the ionizer and the filter element,
wherein the ionizer contains at least one electrode that is or can be connected to a high voltage source for the air filter to generate a corona discharge in the air flow, and at least one counter electrode dedicated to the at least one electrode,
wherein
the at least one counter electrode is electrically connected to an electrically conductive filter layer in the filter element.

2. The air filter according to claim 1, wherein when the air filter is in operation, a first electric potential is or can be applied to the at least one electrode, and a second, different, electric potential is or can be applied to the at least one counter electrode and the filter layer.

3. The air filter according to claim 1, wherein the first electric potential is a supply potential, and the second electric potential forms a counter potential to the supply potential.

4. The air filter according to claim 1, wherein when the air filter is in operation, a negative or positive potential difference (voltage potential) can be or is applied between the at least one electrode and the at least one counter electrode and the filter layer.

5. The air filter according to claim 4, wherein the negative potential difference is within the a range of between −5 kV to −15 kV.

6. The air filter according to claim 1, wherein the ionizer is at a distance to the downstream filter element within the range of 0 mm to 30 mm.

7. The air filter according to claim 1, wherein the filter element contains a dielectric layer for filtering out particles.

8. The air filter according to claim 7, wherein
the dielectric layer is placed on the filter layer on a side (23a) of the filter element facing the ionizer and the air flow, and/or
the dielectric layer is placed on the filter layer on a side (23b) of the filter element facing away from the ionizer and the air flow.

9. The air filter according to claim 1, wherein the filter layer contains or is formed by an electrically conductive layer.

10. The air filter according to claim 1, wherein
the at least one electrode has a needle or cone-shaped electrode body with a central axis,
the at least one counter electrode has an annular or cylindrical counter electrode body that delimits an interior volume,
wherein the electrode body is placed in the counter electrode body such that the central axis of the electrode body is parallel and preferably coaxial to the central axis of the counter electrode body,
wherein the electrode body is substantially entirely, or entirely, inside the interior volume of the counter electrode body, and
wherein a tip of the needle or cone-shaped electrode body faces the air flow.

11. The air filter according to claim 1, wherein
there are two or more electrodes and two or more counter electrodes dedicated to the respective electrodes,
wherein the electrodes are electrically connected to one another,
wherein the counter electrodes are electrically connected to one another.

12. A vehicle air conditioner that is equipped with at least one air filter according to claim 1.

13. The air filter according to claim 5, wherein the potential difference is −7 kV.

14. The air filter according to claim 6, wherein the ionizer is at a distance to the downstream filter of 7 mm.

15. The air filter according to claim 9, wherein the filter layer contains or is formed by an active carbon layer.
